(19) United States
(12) Patent Application Publication
(10) Pub. No.: US 2014/0172428 A1
(43) Pub. Date: Jun. 19, 2014

(54) METHOD AND APPARATUS FOR CONTEXT INDEPENDENT GENDER RECOGNITION UTILIZING PHONEME TRANSITION PROBABILITY

(71) Applicant: Electronics and Telecommunications Research Institute, Daejeon (KR)

(72) Inventor: Mun Sung HAN, Daejeon (KR)

(73) Assignee: Electronics and Telecommunications Research Institute, Daejeon (KR)

(21) Appl. No.: 14/016,611

(22) Filed: Sep. 3, 2013

(30) Foreign Application Priority Data
Dec. 18, 2012 (KR) 10-2012-0148678

(51) Int. Cl. G10L 17/16

(52) U.S. Cl. CPC G10L 17/16
USPC 704/250

(57) ABSTRACT

Provided is a method for context independent gender recognition utilizing phoneme transition probability. The method for the context independent gender recognition includes detecting a voice section from a received voice signal, generating feature vectors within the detected voice section, performing a hidden Markov model on the feature vectors by using a search network that is set according to a phoneme rule to recognize a phoneme and obtain scores of first and second likelihoods, and comparing final scores of the first and second likelihoods obtained while the phoneme recognition is performed up to the last section of the voice section to finally decide gender with respect to the voice signal.

### CROSS-REFERENCE TO RELATED APPLICATIONS

This U.S. non-provisional patent application claims priority under 35 U.S.C. §119 of Korean Patent Application No. 10-2012-0148678, filed on Dec. 8, 2012, the entire contents of which are hereby incorporated by reference.

### BACKGROUND OF THE INVENTION

The present invention disclosed herein relates to a gender recognition field, and more particularly, to a method and apparatus for context independent gender recognition using phoneme transition probability.

In general, image-based gesture recognition technologies or interfaces using sound/voice are being actively studied to satisfy demands with respect to a user interface. Particularly, studies and demands with respect to user recognition or control of various computers on the basis of human sound are increasing in recent years.

A voice interface is one of units that smoothly provide convenience to a user among various user interfaces.

Typical voice recognition technologies are vulnerable to noise environments, and a feature vector is not well appeared in a case of remote voice recognition. However, gender recognition having a high recognition rate under constraint conditions plays a crucial role as a preprocessing process for the voice recognition. As a result, since the gender recognition with respect to a voice signal is important for performance improvement, there is an essential need for applying the gender recognition to fields of customized services or user sensibility analysis.

### SUMMARY OF THE INVENTION

The present invention provides a method and apparatus for context independent gender recognition utilizing phoneme transition probability.

The present invention also provides a method and apparatus for context independent gender recognition which are capable of more discriminately distinguishing a user's gender.

Embodiments of the present invention provide methods for context independent gender recognition, the methods including: detecting a voice section from a received voice signal; generating feature vectors within the detected voice section; performing a hidden Markov model on the feature vectors by using a search network that is set according to a phoneme rule to recognize a phoneme and obtain scores of first and second likelihoods; and comparing final scores of the first and second likelihoods obtained while the phoneme recognition is performed up to the last section of the voice section to finally decide gender with respect to the voice signal.

In some embodiments, each of the feature vectors may be generated by a frame unit, and the phoneme recognition may be performed through HMM recognition constituted by at least three GMMs.

In other embodiments, the generation of the feature vectors may include fusing the feature vectors after a pitch and capstrum of a voice feature are extracted.

In still other embodiments, the fusion of the feature vectors may include mixing the feature vectors to input one feature vector in a classifier.

In even other embodiments, the generation of the feature vectors may include extracting a pitch and capstrum of a voice feature to individually generate probability density functions (PDFs) of the pitch and capstrum, thereby fusing the generated PDFs, and the fusion may include inputting the feature vectors into a classifier to individually obtain the PDFs of the pitch and capstrum, the combining the obtained PDFs.

In yet other embodiments, the set search network may include net groups of an initial phoneme, a medial phoneme, and a final phoneme in Korean language, and the phoneme rule may include a rule according to probability distribution that considers a sequential feature of the phoneme to reflect a phoneme phenomenon.

In other embodiments of the present invention, methods for context independent gender recognition include: combining at least two of energy, pitch, formant, and capstrum of a voice feature to extract feature vectors; and modeling the feature vectors by using a hidden MarKov model (HMM) that reflects transition probability of a phoneme to decide male/female gender with respect to a voice signal.

In some embodiments, when the HMM modeling is performed, a search network that is set according to a phoneme rule may be used.

In other embodiments, each of the feature vectors may be generated by a frame unit of about 10 mm sec, and the HMM modeling may be performed through an HMM recognizer constituted by at least three GMMs.

In still other embodiments of the present invention, apparatuses for context independent gender recognition include: a feature vector generation unit detecting a voice section from a received voice signal to generate feature vectors within the voice section; and a gender recognition unit performing hidden MarKov modeling on the feature vectors by using a search network set according to a phoneme rule to recognize a phoneme.

In some embodiments, the gender recognition unit may include: a score generation part generating scores of first and second likelihoods in every phoneme recognition; and a decision part comparing final scores of the first and second likelihoods obtained while the phoneme recognition is performed up to the last section of the voice section to finally decide gender with respect to the voice signal.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a flowchart illustrating a process of controlling gender recognition having specific extraction and fusion;

FIG. 2 is a block diagram of an apparatus for executing a classification method related to voice recognition;

FIG. 3 is a view illustrating an example of an HMM used for the voice recognition;

FIG. 4 is a view illustrating an example of realization of a search network applied to an embodiment of the present invention; and

FIG. 5 is a flowchart of a gender recognition procedure according to an embodiment of the present invention.

### DETAILED DESCRIPTION OF PREFERRED EMBODIMENTS

Objects, other objects, features, and advantages of the present invention will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

In this specification, it will be understood that when devices or lines are referred to as being connected to an object device block, it can be directly connected to the object device block or indirectly connected to the object device block through the other device.

Also, like or similar reference numerals refer to like or similar elements throughout. In some drawings, connection relationships between the device and circuit block and the lines are illustrated only for effectively explaining technical contents, and thus, the other device or device block or circuit block may be further provided.

An embodiment described and exemplified herein includes a complementary embodiment thereof. Also, it should be noted that detailed operations of gender recognition with respect to typical voice signals and details with respect to a gender recognition circuit will not be described in detail to avoid ambiguous interpretation of the present invention.

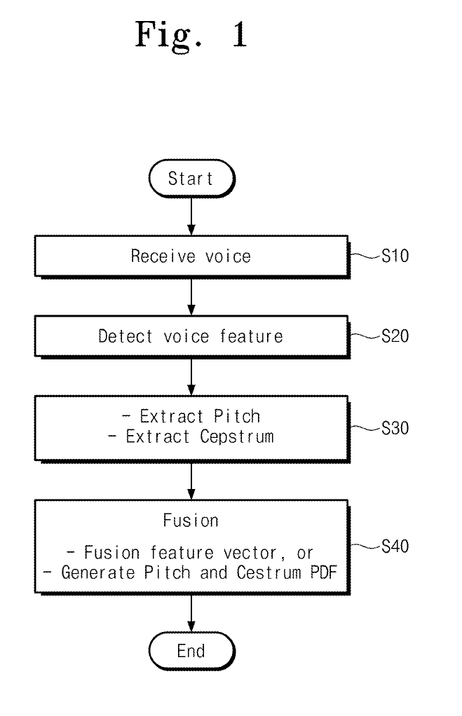

First, a conventional technology that is applicable as a portion of the present invention without other purposes except for provision of further understanding of embodiments of the present invention will be described with reference to FIGS. 1 to 3.

A technology through which whether vocalizer is man or woman is distinguished by using voice (sound) vocalized from the human may be useful in user interface technology fields.

This is done because a service content specialized in a user mode can be provided when sports simulations, home shopping, and services in which determination of user sensibility is needed are required.

Very large factors for distinguishing the gender by using the voice may be referred to as a formant structure feature that varies according to a pitch frequency and a vocal tract which are generated by vibration of vocal cords.

In spite of differences due to a microphone distance and surrounding noises, the male may have a frequency of about 100 Hz to about 150 Hz, and the female may have a frequency of about 250 Hz to about 300 Hz. Thus, the gender recognition using the voice may provide technical possibility having a high recognition rate in actual application environments.

Typical voice recognition technologies are vulnerable to noise environments, and a feature vector is not well appeared in a case of remote voice recognition. However, the gender recognition having the high recognition rate under constraint conditions plays a crucial role for performance improvement of the voice recognition as a preprocessing process for the voice recognition. Thus, technical demands with respect to the gender recognition are increasing in customized services or user sensibility analysis in recent years.

The gender recognition may be generally constituted by two processes.

The first process is a process of extracting a feature from an input signal. Here, a pitch and cepstrum may be mainly utilized in the gender recognition.

The pitch may be a basic frequency of a signal generated by the vibration of the vocal cords in a voiced sound section. This has a disadvantage in that children whose voices have not broken yet make no great difference in spite of a clear difference between the male and the female.

The cepstrum has an advantage in that the same feature value is extracted with respect to the same frequency shape regardless of an intensity of the signal as a feature in which a frequency feature of the vocal tract is reflected.

In addition, the formant spectrum or energy may be utilized. Even though the pitch and capstrum are adequately fused, relatively high performance may be generally secured.

The other one of the two processes for the gender recognition may be a classification process.

The classification process may include a process of setting a pitch and a critical value to classify the gender and a process of classifying the gender into a GMM by using the formant spectrum or a RASTA-PLP as a feature.

FIG. 1 is a flowchart illustrating a process of controlling gender recognition having specific extraction and fusion.

Referring to FIG. 1, a feature extraction process and a fusion process are successively illustrated. In operation S10, a voice signal is received. In operation S20, voice feature detection starts. In operation S30, pitch extraction and capstrum extraction are executed to detect the voice feature.

A method of extracting the pitch includes an autocorrelation method. This is expressed as follows:

R(k)=Σₙ₌₀^{N-1}x(n)×(n+k) [Math Formula 1]

where k=0, . . . , p, . . . , 2p, . . . , 3p, . . . .

According to Math Formula 1, a peak value is obtained in a multiple of a section of the pitch.

The other method for extracting the pitch includes an average magnitude difference function (AMDF) method. This is expressed as follows:

D(k)=Σₙ₌₀^{N-1}|(x)(n)−x(n+k)| [Math Formula 2]

where k=0, . . . , 2p, . . . , 3p, . . . .

The cepstrum may be a feature in which a frequency feature of the vocal tract is reflected. The cepstrum has an advantage in that the shape of the signal is scale-invariant. Examples of a kind of capstrum may include a mel-frequency cepstrum and an LPC cepstrum. The capstrum may be expressed as follows:

$$c ( τ ) = \frac{1}{2 π} {\int }_{- π}^{π} log \vert X ( {e}^{jω} ) \vert \cdot {e}^{jωτ} d ω \qquad [ Math Formula 3 ]$$

where τ=1, 2, . . . , q

As described above, the voice feature extraction method was described. Hereinafter, the feature fusion method will be described.

In operation S40 of FIG. 1, the fusion of feature vectors are executed.

One of the voice feature fusion method may be a feature vector fusion method. This is a method for inputting one feature vector into a classifier by simply adding the feature vectors. This method is simple and effective method.

The other one of the voice feature fusion method may be a fusion method using a PDF.

This is a method in which an individual feature vector is inputted into the classifier to obtain an individual PDF, and then combine the obtained individual PDF. The fusion using the PDF may improve performance when compared to the method in which the classifier is learned and recognized as the individual feature. The fusion using the PDF may obtain significantly high effects in a condition in which the recognition rate is low due to the noise environment.

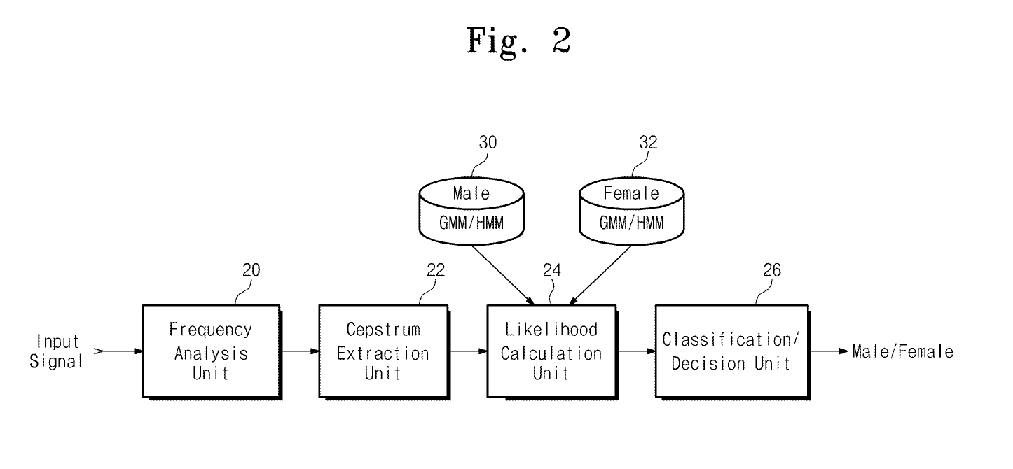

FIG. 2 is a block diagram of an apparatus for executing a classification method related to voice recognition.

Referring to FIG. 2, the apparatus includes a frequency analysis unit 20, a capstrum extraction unit 22, a likelihood calculation unit 24, and a classification/decision unit 26. The likelihood calculation unit 24 uses a male GMM/HMM 30 and a female GMM/HMM 32 when likelihood is calculated.

The apparatus of FIG. 2 may be applicable to voice recognition or vocalizer recognition. The apparatus uses a GMM or HMM-based classification method.

An input signal passes through the frequency analysis unit 20 and the capstrum extraction unit 22 to extract a voice feature at a predetermined distance with respect to a time axis. As a result, the extracted feature vector sequence is applied into the likelihood calculation unit 24 to calculate the likelihood by the GMM or HMM. The classification/decision unit 26 decides a high likelihood score as a gender recognition result.

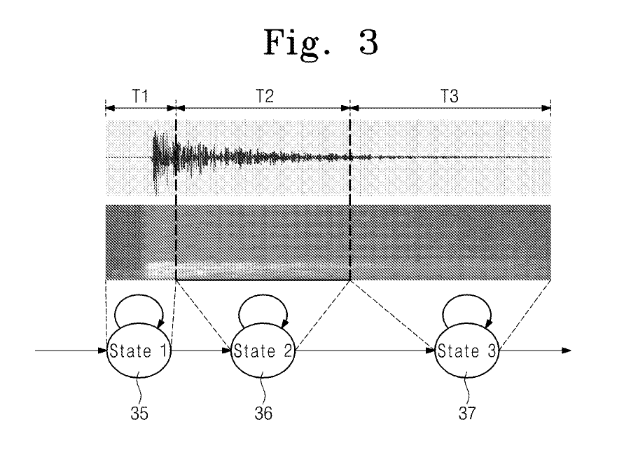

FIG. 3 is a view illustrating an example of an HMM used for the voice recognition.

Referring to FIG. 3, a general example of the HMM is illustrated.

A first state 35 corresponds to a voice section T1, a second state 36 corresponds to a voice section T2, and a third state 37 corresponds to a voice section T3.

Here, each of the states 35, 36, and 37 may be the GMM. Also, three GMMs constitute one HMM. As a result, the example of FIG. 3 shows a left-to-right transition model. The HMM is formed with respect to each phoneme. Thus, the number of states may be adjusted according to a length of the phoneme. Vocalized voice may be recognized as a word or a sentence by connecting the HMM to a network.

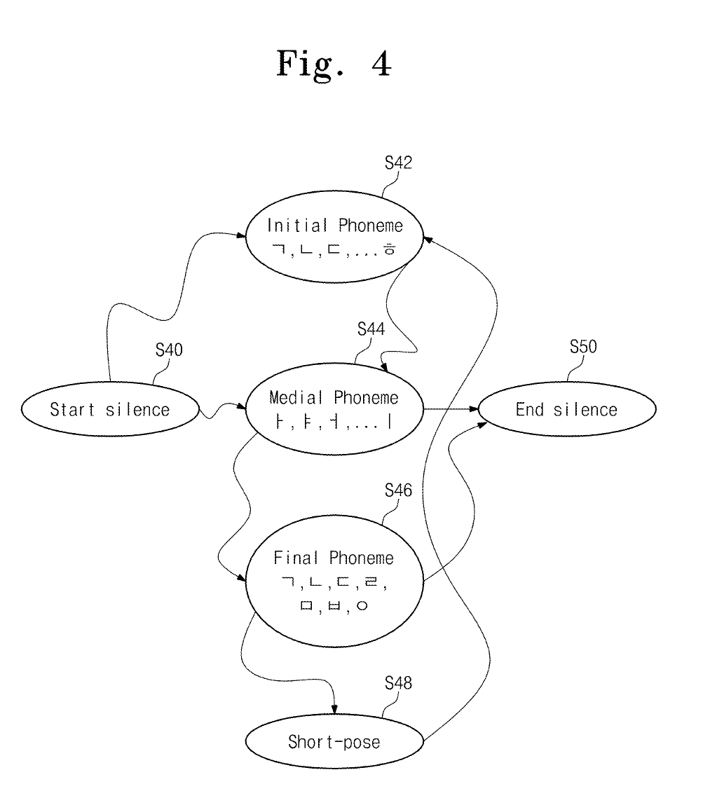

FIG. 4 is a view illustrating an example of realization of a search network applied to an embodiment of the present invention.

Here, FIG. 4 illustrates an example in which a phoneme HMM is connected to the network according to a phoneme rule in a case of Korean language.

The search network for the phoneme recognition is set according to a phoneme rule. Referring to FIG. 4, an initial phoneme group S42, a medial phoneme group S44, a final phoneme group S46, and a short pose S48 are disposed between a start silence S40 and an end silence S50.

For example, if the initial phoneme group S42 is recognized as one phoneme, search with respect to the initial phoneme group S42 and the final phoneme group S46 is excluded in the next process, and a phoneme belong to the medial phoneme group S44 is searched.

As shown in FIG. 4, the method using the search network is superior to the typical GMM-based gander recognition. This is done because a probability distribution model may be estimated in one state in case of the GMM. Thus, in case of the GMM-based gender recognition, probability distribution may be very broad to deteriorate distinction ability of the likelihood score extracted from male/female probability distribution. However, the method illustrated in FIG. 4 in which the model estimation is performed by the HMM according to the network of FIG. 4 improves the distinction ability of the likelihood score because the male/female probability distribution is applied to the phoneme recognition of the voice signal and the feature vectors corresponding to each of phonemes.

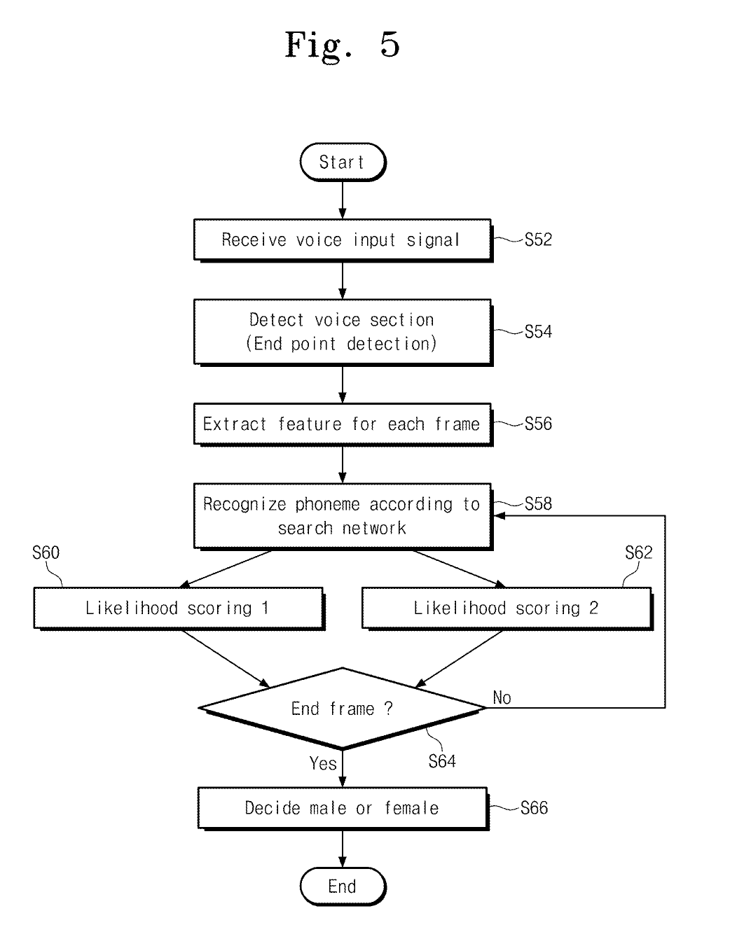

FIG. 5 is a flowchart of a gender recognition procedure according to an embodiment of the present invention.

Referring to FIG. 5, when a voice input signal is received in an operation S52, a voice section is detected in the voice signal in operation S54. Here, a start point and an end point of a voice are detected. In operation S56, a feature for each frame is extracted within the voice section to generate a feature vector. The feature vector may be generated by a unit of 1 frame (e.g., 10 mm sec).

In operation S58, the HMM (hidden MarKov Model) is molded using the search network in which the feature vector is set according to the phoneme rule to recognize a phoneme.

The operation S58 is a process for performing the phoneme recognition with respect to the respective feature vectors through the HMM phoneme recognition, as shown in FIG. 3. The phoneme recognition may be performed according to the phoneme rule of the search network as shown in FIG. 4. For example, if a phoneme “ [symbol] ” is recognized as the previously recognized result, a phoneme that is capable of being recognized at the present may be searched from only the vowels of the medial phoneme group.

As the result of the search, in operations S60 and S62, first and second likelihood scores are obtained. The vowel having the highest likelihood score is decided as the recognized result.

In operation S64, whether the recognized result is an end frame is checked. If the recognized result is not the end frame, the process returns again to the operation S58.

The calculation process of the likelihood may represent a process in which the calculated phoneme HMM score of each of a male (likelihood scoring 1) and a female (likelihood scoring 2) is multiplied by the male/female cores that are calculated up to now.

The multiplying process is repeated up to the last frame of the voice section. Finally, the male score 1 and the female score 2 are compared to each other to decide a high score as the recognition result. That is, when the phoneme recognition is performed up to the last section of the voice section, the final scores of the first and second likelihood are compared to each other in operation S66 to finally decide the gender with respect to the voice signal.

As a result, in an embodiment of the present invention, as shown in FIGS. 3 and 4, the phoneme modeling is performed to search a sequential feature of the phoneme from the voice, and the phoneme is classified by using the hidden Markov model (HMM) on the basis of the sequential feature, thereby improve discernment with respect to the gender.

That is, the method in which the probability distribution for each phoneme and the rule with respect to the sequential feature of the phoneme are molded as a transition probability may be improved in discernment when compared to the method in which probabilities of all phoneme information are estimated as only one state.

As a result, the embodiment of the present invention may have relative advantages as follows.

In a case of typical technologies, there is a method in which feature vectors having clear differences in gender classification such as pitch, energy, and capstrum are mixed with a critical value and a decision rule. However, the method has not regard for various phoneme phenomena.

On the other hand, according to the embodiment of the present invention, the gender may be classified in consider of the sequential probability distribution of the phoneme to improve reliability.

Also, the GMM is used as the typical classifier. In this case, the probability distribution model is estimated in one state to deteriorate the discernment due to the broad possibility distribution. Also, in the embodiment of the present invention, since the male/female possibility distribution is calculated by using the feature vector corresponding to each phoneme, the discernment of the likelihood may increase.

Furthermore, in the embodiment of the present invention, since the male/female gender is decided by utilizing the calculated probability density function of each feature vector, the fusion of the feature vectors may be superior to a case in which a statistical feature is decided by at least individual feature vector.

In the embodiment of the present invention, sine the network is constituted in consideration of the sequential feature of the phoneme to calculate the possibility value of the voice, the reliability may be improved when compared to the calculation using the mixed phoneme.

A Gaussian mixture model (GMM) may be a kind of hidden Markov model (HMM), i.e., a 1 state HMM. Also, the HMM-based gender recognition performance was confirmed through the simple gender recognition experiment.

According to the present invention, since the phoneme transition probability is utilized, the male/female distinction ability for recognizing the gender may be improved when compared to that according to the typical technology.

The embodiments are disclosed in the drawings and this specification as described above. While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method for context independent gender recognition, the method comprising:
detecting a voice section from a received voice signal;
generating feature vectors within the detected voice section;
performing a hidden Markov model on the feature vectors by using a search network that is set according to a phoneme rule to recognize a phoneme and obtain scores of first and second likelihoods; and
comparing final scores of the first and second likelihoods obtained while the phoneme recognition is performed up to the last section of the voice section to finally decide gender with respect to the voice signal.

2. The method of claim 1, wherein the feature vectors are generated by a frame unit.

3. The method of claim 1, wherein the phoneme recognition is performed through HMM recognition constituted by at least three GMMs.

4. The method of claim 1, wherein the generation of the feature vectors comprises fusing the feature vectors after a pitch and capstrum of a voice feature are extracted.

5. The method of claim 4, wherein the fusion of the feature vectors comprises mixing the feature vectors to input one feature vector in a classifier.

6. The method of claim 1, wherein the generation of the feature vectors comprises extracting a pitch and capstrum of a voice feature to individually generate probability density functions (PDFs) of the pitch and capstrum, thereby fusing the generated PDFs.

7. The method of claim 6, wherein the fusion comprises inputting the feature vectors into a classifier to individually obtain the PDFs of the pitch and capstrum, the combining the obtained PDFs.

8. The method of claim 1, wherein the set search network comprises net groups of an initial phoneme, a medial phoneme, and a final phoneme in Korean language.

9. The method of claim 1, wherein the phoneme rule comprises a rule according to probability distribution that considers a sequential feature of the phoneme to reflect a phoneme phenomenon.

10. A method for context independent gender recognition, the method comprising:
combining at least two of energy, pitch, formant, and capstrum of a voice feature to extract feature vectors; and
modeling the feature vectors by using a hidden MarKov model (HMM) that reflects transition probability of a phoneme to determine male/female gender with respect to a voice signal.

11. The method of claim 10, wherein, when the HMM modeling is performed, a search network that is set according to a phoneme rule is used.

12. The method of claim 10, wherein each of the feature vectors is generated by a frame unit of about 10 mm sec.

13. The method of claim 11, wherein the HMM modeling is performed through an HMM recognizer constituted by at least three GMMs.

14. An apparatus for context independent gender recognition, the apparatus comprising:
a feature vector generation unit configured to detect a voice section from a received voice signal to generate feature vectors within the voice section; and
a gender recognition unit configured to perform hidden MarKov modeling on the feature vectors by using a search network set according to a phoneme rule to recognize a phoneme.

15. The apparatus of claim 14, wherein the gender recognition unit comprises:
a score generation part generating scores of first and second likelihoods in every phoneme recognition; and
a decision part comparing final scores of the first and second likelihoods obtained while the phoneme recognition is performed up to the last section of the voice section to finally decide gender with respect to the voice signal.
